(19) United States
(12) Patent Application Publication
(10) Pub. No.: US 2026/0175800 A1
(43) Pub. Date: Jun. 25, 2026

(54) VEHICLE POWER SUPPLY SYSTEM

(71) Applicant: TOYOTA JIDOSHA KABUSHIKI KAISHA, Toyota-shi (JP)

(72) Inventor: Satoru TAKEMOTO, Okazaki-shi (JP)

(73) Assignee: TOYOTA JIDOSHA KABUSHIKI KAISHA, Toyota-shi (JP)

(21) Appl. No.: 19/366,941

(22) Filed: Oct. 23, 2025

(30) Foreign Application Priority Data
Dec. 20, 2024 (JP) 2024-225565

(51) Int. Cl. B60R 16/023; B60R 16/033; H02J 9/06

(52) U.S. Cl. CPC B60R 16/0238; B60R 16/033; H02J 9/061

(57) ABSTRACT

A vehicle power supply system for supplying electric power to a load mounted on a vehicle, comprising: a main power supply source; a sub-power supply source; a main power distribution control unit for distributing and supplying electric power of the main power supply source to a plurality of first loads; and a sub-power distribution control unit for distributing and supplying electric power of the sub-power supply source to the plurality of second loads and being connected to the main power distribution control unit so as to be capable of supplying electric power of the sub-power supply source via a switch, wherein when the switch is in a first state capable of supplying electric power from the sub-power supply source to the plurality of second loads, the switch is controlled to a cut-off state.

### CROSS-REFERENCE TO RELATED APPLICATION

This application claims priority to Japanese Patent Application No. 2024-225565 filed on Dec. 20, 2024. The disclosure of the above-identified application, including the specification, drawings, and claims, is incorporated by reference herein in its entirety.

### BACKGROUND

### 1. Technical Field

The present disclosure relates to a system that supplies electric power to a load mounted on a vehicle.

### 2. Description of Related Art

Japanese Patent No. 7398410 discloses a vehicle power supply system that allows reducing the diameter of a power supply line in a wire harness and reducing power loss while suppressing an increase in the cost of the entire vehicle. It is indicated that this vehicle power supply system reduces the power loss by supplying power at a voltage of 48 V to a high-power load and supplying power at a voltage of 12 V, obtained by stepping down the voltage of 48 V, to a low-power load.

### SUMMARY

There is a vehicle power supply system 500 that includes a direct-current (DC)/DC converter (DDC) 510 and a battery 520 as a power supply source, and a power distribution control unit 530 including a plurality of switches 531 to 536, as illustrated in FIG. 4, and that supplies power to a plurality of loads 540 to 560.

In the vehicle power supply system 500, an attempt is made to add a load to which power is distributed from the power distribution control unit 530, such as by adding in-vehicle equipment. In this case, it is necessary to increase the output capacity of the DC/DC converter 510, increase the capacity of the battery 520, and increase the control capacity of the power distribution control unit 530, in order to support the additional load. Therefore, there is an issue that the size and the cost of the vehicle power supply system 500 are increased due to the need to change the existing configuration. The present disclosure has been made in view of the above issue, and an object

of the present disclosure is to provide a vehicle power supply system that allows increasing supply power to support an additional load without affecting the existing configuration.

In order to address the above issue, an aspect of the present disclosure provides a vehicle power supply system that supplies electric power to a load mounted on a vehicle, including:
a main power supply source;
a sub-power supply source;
a main power distribution control unit that distributes and supplies electric power of the main power supply source to a plurality of first loads; and
a sub-power distribution control unit that distributes and supplies electric power of the sub-power supply source to a plurality of second loads, the sub-power distribution control unit being connected to the main power distribution control unit so as to be able to supply the electric power of the sub-power supply source via a switch, in which
the switch is controlled to a disconnected state when in a first state in which power supply from the sub-power supply source to the second loads is possible.

According to the vehicle power supply system of the present disclosure, it is possible to increase power that can be supplied to support an additional load without affecting the existing configuration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a configuration including a vehicle power supply system and a peripheral portion thereof according to an embodiment of the present disclosure;

FIG. 2 shows a variant of an additional power supply;

FIG. 3 is a diagram illustrating an example of a vehicle power supply system connected to a load of a zonal configuration; and

FIG. 4 is a schematic view of a configuration including a conventional vehicle power supply system and a peripheral portion thereof.

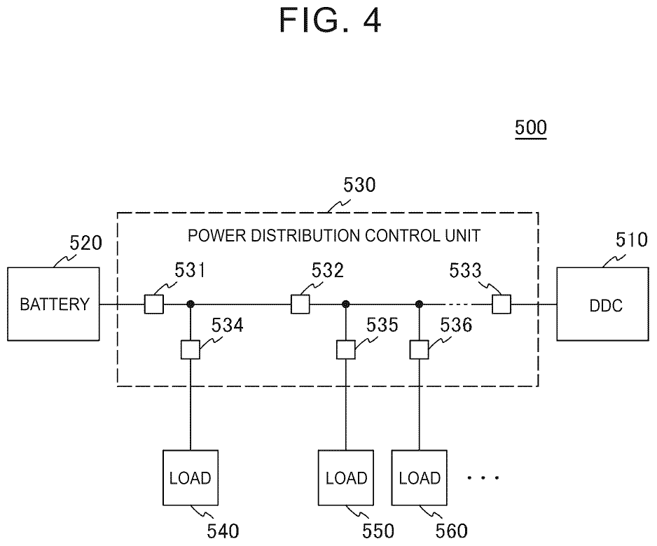

### DETAILED DESCRIPTION OF EMBODIMENTS

In the vehicle power supply system of the present disclosure, when a load is added to the basic load configuration of the vehicle from the rear, the power supply to the non-addition is provided by the additional configuration instead of the existing configuration. Therefore, it is possible to increase the power that can be supplied corresponding to the additional load without affecting the existing configuration (while maintaining the current rating).

Hereinafter, an embodiment of the present disclosure will be described in detail with reference to the drawings.

### Embodiment

### Configuration

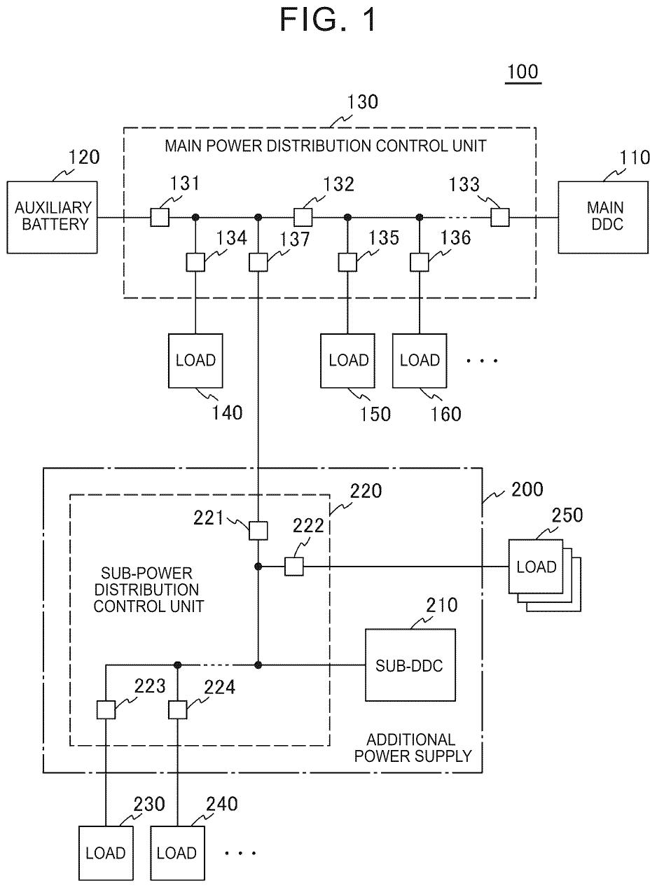

FIG. 1 is a schematic diagram illustrating an example of a configuration including a vehicle power supply system 100 and a peripheral portion thereof according to an embodiment of the present disclosure. The vehicle power supply system 100 illustrated in FIG. 1 includes a main DC/DC converter (main DDC) 110, an auxiliary battery 120, a main power distribution control unit 130, and an additional power supply 200. The vehicle power supply system 100 is mounted on a vehicle, for example.

The main DC/DC converter 110 is a power converter for inputting power from a high-voltage battery (not shown) such as a lithium-ion battery, converting a voltage (for example, 48V) of the input power of the high-voltage battery into a required voltage (for example, 12V), and outputting the voltage to the main power distribution control unit 130.

The auxiliary battery 120 is a secondary battery configured to be chargeable and dischargeable, such as a lithium ion battery. The auxiliary battery 120 can supply the electric power stored therein to the main power distribution control unit 130. The main power distribution control unit 130 is a configuration (such as a

power distribution ECU) for supplying and controlling power to and from a plurality of loads 140 to 160 (the first load) such as many devices and apparatuses mounted on vehicles using the main DC/DC converter 110 and the auxiliary battery 120 as power supply sources (main power supply sources). The main power distribution control unit 130 supplies and controls power via a plurality of switches 131 to 137. Semiconductor relays are used for the plurality of switches 131 to 137. The number and arrangement of the plurality of switches 131 to 137 illustrated in FIG. 1 are merely examples, and are not limited thereto.

The additional power supply 200 functions as a power supply for a plurality of loads 230 to 250 mounted in addition to the vehicle by addition of equipment, specifications, or the like. The additional power supply 200 includes a sub-DC/DC converter (sub-DDC) 210 and a sub-power distribution control unit 220.

The sub-DC/DC converter 210 is a power converter for inputting power from the same high voltage battery (not shown) as the main DC/DC converter 110, converting a voltage (for example, 48V) of the input power of the high voltage battery into a required voltage (for example, 12V), and outputting the required voltage to the sub-power distribution control unit 220.

The sub-power distribution control unit 220 is a configuration (such as a power distribution ECU) for supplying and controlling power to a plurality of loads 230 to 250 (second loads) additionally mounted on the vehicle using the sub-DC/DC converters 210 as a power supply source (sub-power supply source). The sub-power distribution control unit 220 supplies and controls power via the plurality of switches 221 to 224. Semiconductor relays are used for the plurality of switches 221 to 224. The number and arrangement of the plurality of switches 221 to 224 illustrated in FIG. 1 are merely examples, and are not limited thereto.

### Modified Example

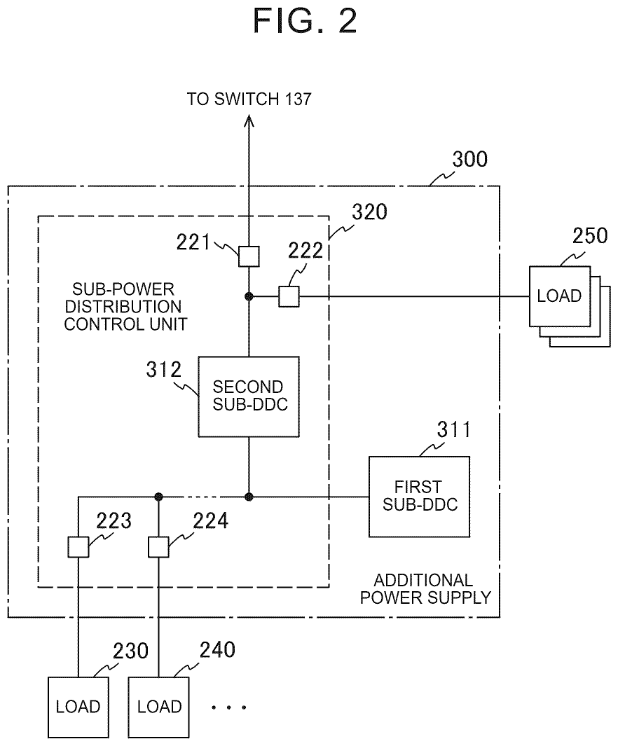

FIG. 2 is a modification of the vehicle power supply system 100 using an additional power supply 300 having a configuration different from that of the additional power supply 200. The additional power supply 300 according to this modification can be applied to a case where a load operating at a different voltage is included in a plurality of loads 230 to 250 (second loads) additionally mounted on the vehicle.

The additional power supply 300 includes a first sub-DC/DC converter (first sub-DDC) 311 and a sub-power distribution control unit 320. The sub-power distribution control unit 320 includes a second sub-DC/DC converter (second sub-DDC) 312 and a plurality of switches 221 to 224.

The first sub-DC/DC converters 311 adjust the voltage of the electric power inputted from the high voltage battery to the voltage (e.g., 48V) required by the loads 230 and 240, and outputted to the sub-power distribution control unit 320. The second sub-DC/DC converter 312 converts the voltage (e.g., 48V) of the power inputted from the first sub-DC/DC converter 311 to the voltage (e.g., 12V) required by the loads 250.

The additional power supply 300 configured by using the plurality of first sub-DC/DC converters 311 and the second sub-DC/DC converters 312 can supply the optimum-voltage power to the plurality of loads 230 to 250.

### Application Example

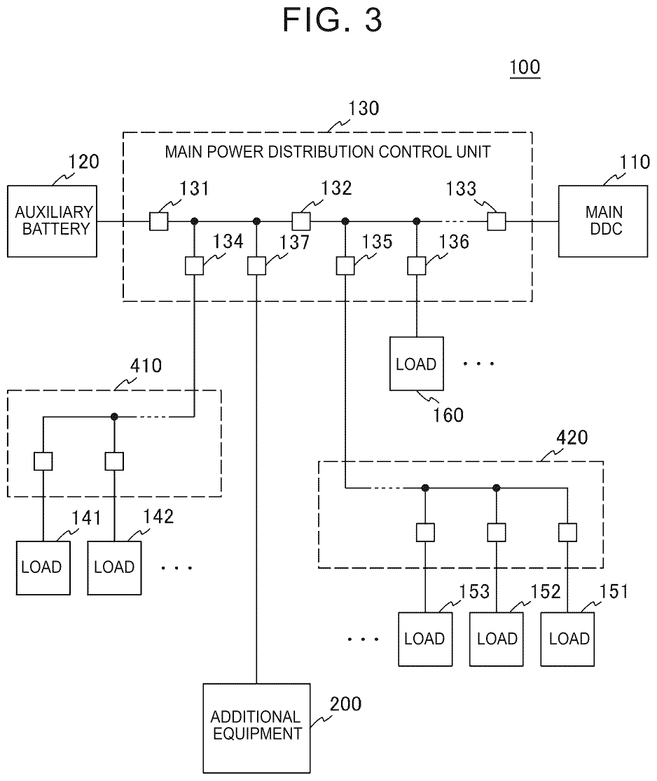

The vehicle power supply system 100 of the present embodiment can also be connected to a load in a zone configuration as shown in FIG. 3. In the zone configuration illustrated in FIG. 3, the load 140 connected to the main power distribution control unit 130 (zone 1) is replaced by a plurality of loads 141, 142 connected to the power distribution control unit 410 (zone 2). In the zone configuration illustrated in FIG. 3, the load 150 connected to the main power distribution control unit 130 (zone 1) is replaced by a plurality of loads 151, 152, 153 connected to the power distribution control unit 420 (zone 3).

The vehicle power supply system 100 of the present embodiment can also be applied to such a load having a zone configuration.

### Control

Next, an example of control performed in the vehicle power supply system 100 according to an embodiment of the present disclosure will be described.

As a basic control of the vehicle power supply system 100, in order to cause the additional power supply 200 to function as a dedicated power supply for the plurality of loads 230 to 250, at least one of the switch 137 of the main power distribution control unit 130 and the switch 221 of the sub-power distribution control unit 220 is controlled to a cutoff state when power can be supplied from the sub-DC/DC converters 210 (sub-power supply source) to the plurality of loads 230 to 250 (second load) (first state).

By this control, the main DC/DC converter 110 and the auxiliary battery 120 (main power supply source) can be separated from the sub-DC/DC converter 210 (sub-power supply source). Therefore, it is possible to suppress the flow of unnecessary current from the main power supply source to the sub-power distribution control unit 220 and the flow of unnecessary current from the sub-power supply source to the main power distribution control unit 130. In addition, the dark current can be supplied from only the main power supply source to the plurality of loads 140 to 160 (the first load) when the vehicle is parked. This suppresses the sub-DC/DC converters 210 (sub-power supply source) operating frequently and reduces power dissipation during parking.

Further, as the extended control of the vehicle power supply system 100, when power cannot be supplied from the sub-DC/DC converter 210 (sub-power supply source) to the plurality of loads 230 to 250 (second load) (second state), all of the switches 131, 132, 133, and 137 of the main power distribution control unit 130 and the switches 221 of the sub-power distribution control unit 220 are controlled to be in a conductive state. This second condition can be illustrated when the rise of the sub-DC/DC converter 210 is slower than the rise of the main DC/DC converter 110, such as immediately after DC/DC of the vehicle is activated.

By this control, the power of the main DC/DC converter 110 and the auxiliary battery 120 (main power supply source) can be temporarily supplied from the plurality of loads 230 to 250 (second load) until the sub-DC/DC converter 210 (sub-power supply source) is ready to be supplied with power.

Further, as a further expansion control of the vehicle power supply system 100, when the main DC/DC converter 110 and the auxiliary battery 120 (main power supply source) are in a failed state (third state), the switches 131 and 133 of the main power distribution control unit 130 are controlled to be in a shut-off state, and all of the switches 132 and 137 of the main power distribution control unit 130 and the switches 221 of the sub-power distribution control unit 220 are controlled to be in a conductive state.

By this control, in place of the main DC/DC converter 110 and the auxiliary battery 120 (main power supply source), power can be backed up and supplied from the sub-DC/DC converter 210 (sub-power supply source) to a load that is included in the plurality of loads 140 to 160 (first load) and needs to limp home in an emergency.

### Operations and Effects

As described above, according to the vehicle power supply system 100 according to the embodiment of the present disclosure, the vehicle power supply system includes the main DC/DC converter 110, the auxiliary battery 120 (main power supply source), and the sub-DC/DC converter 210 (sub-power supply source). According to the vehicle power supply system 100 according to an embodiment of the present disclosure, a main power distribution control unit 130 that distributes and supplies electric power of the main DC/DC converters 110 and the auxiliary battery 120 from a plurality of loads (first loads) 140 to 160 is provided. According to the vehicle power supply system 100 according to an embodiment of the present disclosure, the power of the sub-DC/DC converter 210 is distributed and supplied to the plurality of loads (second loads) 230 to 250, and the sub-power distribution control unit 220 is connected to the main power distribution control unit 130 so as to be capable of supplying the power of the sub-DC/DC converter 210 via the switch 221. According to the vehicle power supply system 100 of the present embodiment, the switch 221 is controlled to be in the cutoff state when the power supply from the sub-DC/DC converters 210 to the plurality of second loads 230 to 250 is in the first state.

This configuration and control can increase the power that can be supplied in response to additional loads without affecting existing configurations. Further, the additional power supply 200 may be limited to be added to the vehicle power supply system 100 only when the second loads 230 to 250 are optionally added to the vehicle.

When the additional power supply 200 is added to the vehicle power supply system 100, a part of the loads 140 to 160 connected to the main power distribution control unit 130 may be connected to the sub-power distribution control unit 220. Further, a part of the second loads 230 to 250 connected to the sub-power distribution control unit 220 of the additional power supply 200 may be connected to the main power distribution control unit 130. The replacement of the load can be arbitrarily performed according to the mounting position and the mounting position of the load in the vehicle. The vehicle power supply system of the present disclosure can be used for a

vehicle or the like using a configuration in which the power supply capability is controlled by DC/DC converters (current-output ratings) and power distribution ECU (heat generation).

What is claimed is:

1. A vehicle power supply system that supplies electric power to a load mounted on a vehicle, comprising:
a main power supply source;
a sub-power supply source;
a main power distribution control unit that distributes and supplies electric power of the main power supply source to a plurality of first loads; and
a sub-power distribution control unit that distributes and supplies electric power of the sub-power supply source to a plurality of second loads, the sub-power distribution control unit being connected to the main power distribution control unit so as to be able to supply the electric power of the sub-power supply source via a switch, wherein
the switch is controlled to a disconnected state when in a first state in which power supply from the sub-power supply source to the second loads is possible.

2. The vehicle power supply system according to claim 1, wherein the switch is controlled to a conductive state when in a second state in which the power supply from the sub-power supply source to the second loads is impossible.

3. The vehicle power supply system according to claim 1, wherein the switch is controlled to a conductive state when in a third state in which the main power supply source is backed up by the sub-power supply source.
